(19) United States
(12) Patent Application Publication
(10) Pub. No.: US 2023/0086324 A1
(43) Pub. Date: Mar. 23, 2023

(54) RESISTANCE WELDING APPARATUS AND METHOD

(71) Applicant: Wichita State University, Wichita, KS (US)

(72) Inventors: Waruna P. Seneviratne, Wichita, KS (US); John S. Tomblin, Wichita, KS (US); Brandon L. Saathoff, Wichita, KS (US); Mark T. Walthers, Wichita, KS (US); Carleton A. Hall, Wichita, KS (US)

(21) Appl. No.: 17/933,499

(22) Filed: Sep. 20, 2022

Related U.S. Application Data
(60) Provisional application No. 63/262,501, filed on Oct. 14, 2021.
(60) Provisional application No. 63/261,364, filed on Sep. 20, 2021.

(51) Int. Cl. B23K 11/24; B23K 11/16; B23K 11/36; B29C 65/30

(52) U.S. Cl. CPC B23K 11/241; B23K 11/16; B23K 11/36; B29C 65/30; B23K 2103/42

(57) ABSTRACT

A resistance welding apparatus can employ a modular power supply system with multiple power supply modules and leads for electrically connecting the modular power supply system to a welding resistor. The resistance welding apparatus is selectively configurable in at least three of (i) a first configuration in which the leads connect the first power supply module to the resistor and the second power supply module is disconnected from the resistor; (ii) a second configuration in which the leads connect the second power supply module to the resistor and the first power supply module is disconnected from the resistor; (iii) a third configuration in which the leads connect the first and second power supply modules to the resistor in series; and (iv) a fourth configuration in which the leads connect the first and second power supply modules to the resistor in parallel.

### CROSS-REFERENCE TO RELATED APPLICATION

This application claims priority to U.S. Provisional Patent Application No. 63/262,501, filed Oct. 14, 2021, and to U.S. Provisional Patent Application No. 63/261,364, filed Sep. 20, 2021, each of which is hereby incorporated by reference in its entirety for all purposes.

### FIELD

The present disclosure generally relates to apparatuses, systems, and methods for resistance welding.

### BACKGROUND

Resistance welding involves passing an electric current through an electrically resistive heating element placed between two substrates to generate localized heat at the interface. The heat generated at the interface melts the polymer and joins the materials under applied pressure. Resistance welding is used to join thermoplastic parts, for example. The inventors believe that existing thermoplastic welding systems have limited capability. For instance, the inventors have recognized that existing thermoplastic welding systems are often only capable of performing one type of weld operation.

### SUMMARY

In one aspect, a resistance welding apparatus for welding thermoplastic parts together at a weld interface is disclosed with a heating element (i.e., a resistor) is disposed between the thermoplastic parts. The resistance welding apparatus comprises a modular power supply system comprising a first power supply and a second power supply module and leads for electrically connecting the modular power supply system to the heating element to output current from the modular power supply system to the heating element. The resistance welding apparatus is selectively configurable in at least three of four configurations. In the first configuration, the leads connect the first power supply module to the heating element and the second power supply module is disconnected from the heating element; in the second configuration, the leads connect the second power supply module to the heating element and the first power supply module is disconnected from the heating element; in the third configuration, the leads connect the first and second power supply modules to the heating element in series; and in the fourth configuration, the leads connect the first and second power supply modules to the heating element in parallel.

In another aspect, a resistance welding apparatus for welding thermoplastic parts together at a weld interface in which a heating element (i.e., a resistor) is disposed between the thermoplastic parts is disclosed. The resistance welding apparatus comprises an apparatus enclosure, a resistance welding power supply system received in the apparatus enclosure and configured to selectively output current to the heating element, a power connector configured to connect the power supply system to a main power source, an HMI device configured to receive user input selecting a weld control routine, and a weld controller configured to control the power supply system to execute a weld control routine selected by user input to the HMI device. At least one of (i) the power connector is supported on the apparatus enclosure or connected to the apparatus enclosure by a cable extending from the apparatus enclosure, (ii) the HMI device is supported on the apparatus enclosure, and (iii) the weld controller is received in on the apparatus enclosure.

In another aspect, a resistance welding apparatus for welding thermoplastic parts together at a weld interface is disclosed in which a heating element (i.e., a resistor) is disposed between the thermoplastic parts. The resistance welding apparatus comprises an apparatus enclosure, a resistance welding power supply system received in the apparatus enclosure and configured to selectively output current to the heating element, a plurality of temperature sensor connectors on the apparatus enclosure, and a weld controller connected to the plurality of temperature sensor connectors. The weld controller is configured to control the power supply system to execute a weld control routine based on one or more temperature signals from one or more sacrificial temperature sensor connectors. Each temperature sensor connector is configured to connect to a sacrificial temperature sensor that may be disposed at the interface of the thermoplastic parts while they are being welded together to output a temperature signal representative of temperature of the weld interface during welding.

In yet another aspect, a resistance welding apparatus for welding thermoplastic parts together at a weld interface is disclosed in which a heating element (i.e., a resistor) is disposed between the thermoplastic parts. The resistance welding apparatus comprises a resistance welding power supply system configured to selectively output current to the heating element, a weld controller configured to control the power supply system to selectively output current to the heating element to repeatably execute weld routines, and a feedback circuit providing information about the current output from the resistance welding power supply during execution of weld routine. The weld controller is configured to connect to one or more sacrificial temperature sensors that may be disposed at the interface of the thermoplastic parts while they are being welded together to output a temperature signal representative of the temperature of the weld interface during welding. The weld controller is configured to selectively control weld routines based on feedback from either of (1) one or more sacrificial temperature sensors and (2) the feedback circuit.

In yet another aspect, a method of developing a resistance welding process. The method comprises using a weld controller to control a resistance welding power supply of a resistance welding apparatus to output current to a heating element (i.e., a resistor) at a weld interface between thermoplastic parts to adjust the weld interface to a predefined set point temperature based on feedback from one or more sacrificial temperature sensors connected to one or more temperature sensor connectors integrated into the resistance welding apparatus and storing information about the current output to the heating element during the preceding step.

Other objects and features of the present disclosure will be in part apparent and in part pointed out herein.

### BRIEF DESCRIPTION OF THE DRAWINGS

FIG. 1 is a schematic illustration of a resistance welding system in accordance with the present disclosure;

FIG. 2 is a perspective of a resistance welding apparatus of the resistance welding system;

FIG. 3 is an elevation of the resistance welding apparatus;

FIG. 4 is another elevation of the resistance welding apparatus schematically illustrating certain electronic components;

FIG. 5 is another elevation of the resistance welding apparatus schematically illustrating power supply modules thereof located inside an enclosure of the resistance welding apparatus;

FIG. 6 is a schematic block diagram of control architecture for the resistance welding system;

FIG. 7 is a partial screen shot showing a user interface of weld control software that enables a user to configure a weld control routine; and

FIG. 8 is a partial screen shot showing a user interface of weld control software that enables a user to view weld process data.

Corresponding reference numbers indicate corresponding parts throughout the drawings.

### DETAILED DESCRIPTION

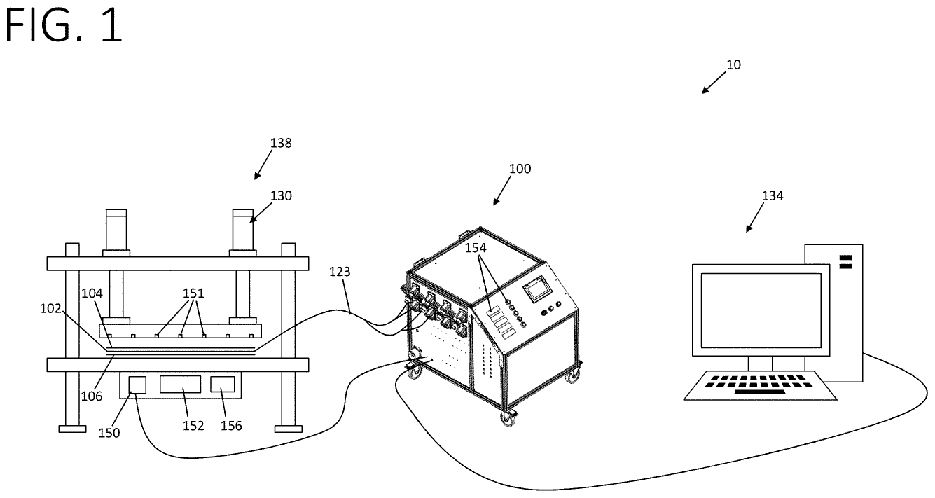

Referring to FIG. 1, an exemplary embodiment of a resistance welding system is generally indicated at reference numeral 10. The resistance welding system 10 is broadly configured to join together two separate work pieces 104, 106 (e.g., thermoplastic work pieces formed, for example, from thermoplastic composite material such as a carbon fiber composite or other fiber-reinforced composite) by passing current through one or more heating elements (i.e., resistors) 102 positioned at an interface between the work pieces. The illustrated resistance welding system generally comprises a resistance welding apparatus 100, a remote control station 134, and resistance welding tooling 138. As will be explained in further detail below, resistance welding apparatus 100 is configured to automatically control resistance welding operations based on predefined weld control routines. Moreover, the resistance welding apparatus 100 is configured to connect to the resistance welding tooling 138 to control the resistance welding tooling during resistance welding operations. As will be further explained below, the control station 134 is broadly configured to enable a user to define weld control routines for execution by the welding apparatus. Furthermore, the control station 134 is connected to the resistance welding apparatus 100 to receive information about the welding operations being performed, which enables a user of the system 10 to conduct process development and/or process validation.

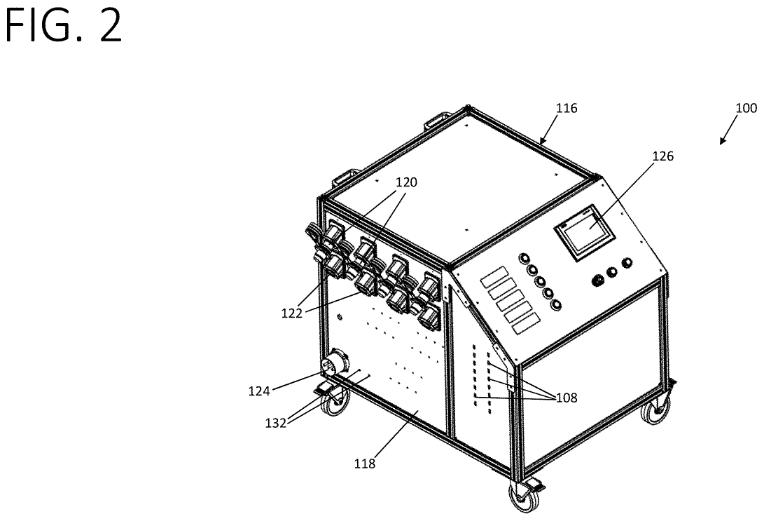

Referring to FIGS. 2-5, the resistance welding apparatus 100 includes an apparatus enclosure 116 that, in the illustrated embodiment, holds the componentry of the apparatus on a single contiguous footprint. The apparatus enclosure 116 suitably comprises a set of walls held together on a frame.

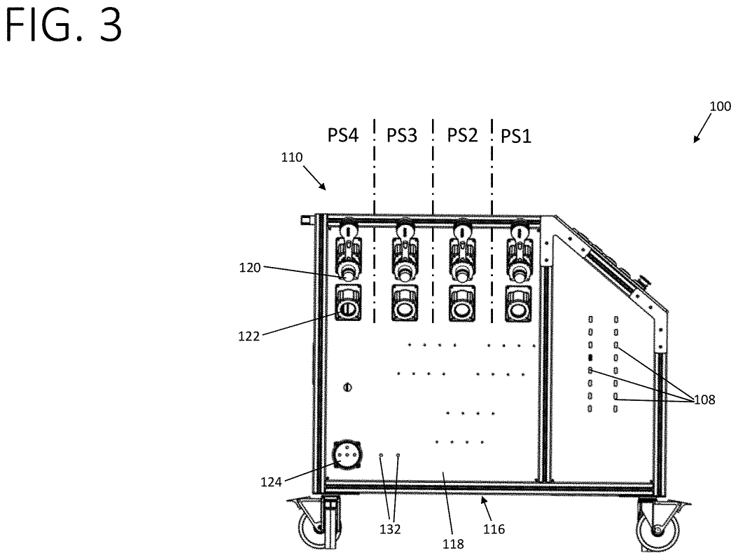

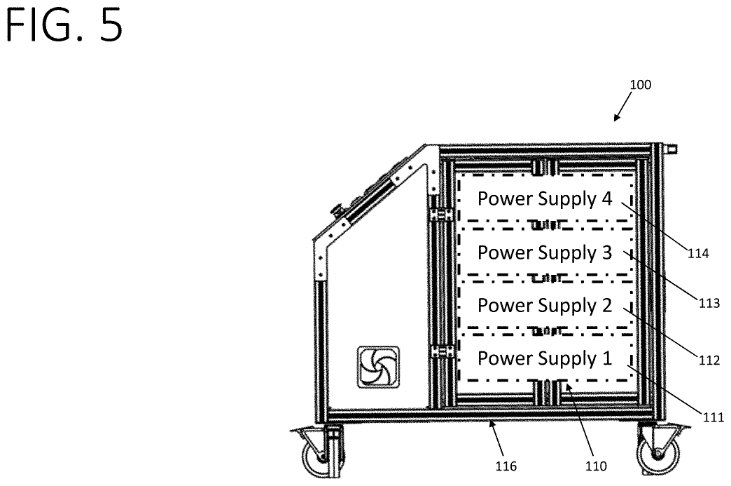

Referring to FIGS. 3 and 5, the resistance welding apparatus 100 further includes a modular power supply system 110 supported in the apparatus enclosure 116. The modular power system 110 comprises a plurality of power supply modules 111, 112, 113, 114. In the illustrated embodiment, the modular power system 110 includes a first power supply module 111, a second power supply module 112, a third power supply module 113, and a fourth power supply module 114. However, the disclosure is not strictly limited to modular power supply systems with four power supply modules. Modular power supply systems with other numbers of power supply modules may be used in one or more embodiments. Furthermore, non-modular power supplies, such as power supplies made up of a single power supply component, are also contemplated in the scope of the disclosure.

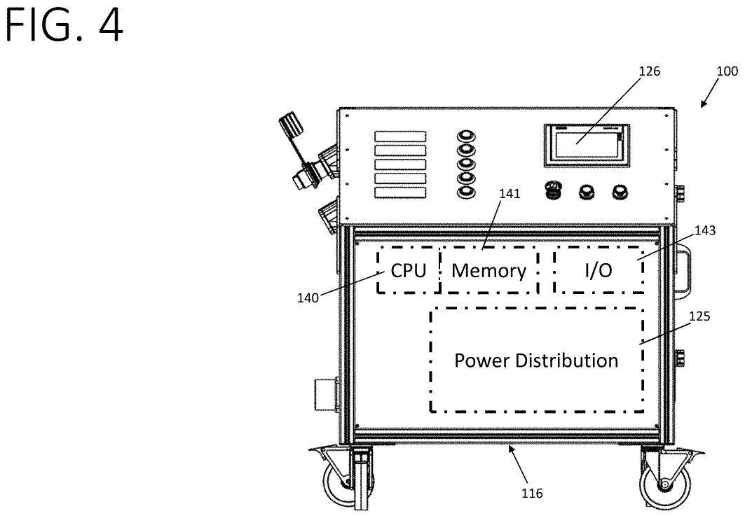

Each power supply module 111, 112, 113, 114 is connected by relays to a positive terminal 120 and a negative terminal 122. FIG. 3 schematically illustrates which power supply 111, 112, 113, 114 each pair of terminals is connected to by demarking zones PS1, PS2, PS3, PS4. In the illustrated embodiment, the terminals 120, 122 in zone PS1 are connected to power supply module 111; the terminals 120, 122 in zone PS2 are connected to power supply module 112; the terminals 120, 122 in zone PS3 are connected to power supply module 113; and the terminals 120, 122 in zone PS4 are connected to power supply module 114. In the illustrated embodiment, the positive terminals 120 and the negative terminals 122 are located on a wall 118 of the enclosure 116 such that they are accessible on the exterior of the enclosure 116. A power supply input 124 (e.g., a 440V power supply input) for the apparatus 100 is also provided on the same wall 118 in the illustrated embodiment. A power distribution unit 125 (FIG. 4) distributes power from the input 124 to the apparatus 100. A user can run leads 123 (FIG. 1) from any of the terminals 120, 122 to the heating element 102 to selectively connect one or more power supply modules 111, 112, 113, 114 to the heating element for powering a weld. In addition, the user can connect leads 123 between the terminals 120, 122 of a plurality of power supply modules 111, 112, 113, 114 to combine selected power supplies together in series or parallel circuits. The leads 123 can be any suitable power cable rated for carrying the currents intended and capable of connecting to the terminals 120, 122, the heating element resistor 102, and other leads.

In general, the power supply system 110 is configured to output current to the heating element 102 to power the welding operation. The illustrated modular power supply system 110 is selectively configurable in a plurality of different configurations in order to provide a wide range of current and voltage outputs suitable for a wide range of welds. By utilizing the terminals 120, 122, any single one of the power supply modules 111, 112, 113, 114 or any combination of a plurality of the power supply modules can be selected to power the welding operation. When a plurality of power supply modules is used, the modular power supply system 110 enables the power supply modules to be connected in parallel or in series to adjust the current and voltage ranges in order to increase total power output, depending on the different types and sizes of the heating elements 102 in use.

In an exemplary embodiment, one power supply module 111 is a low voltage/high current (LVHC) power supply module and a plurality of other power supply modules 112, 113, 114 are high voltage/low current (HVLC) power supply modules. For example, the first power supply module 111 has a voltage rating (corresponding to a maximum voltage output) less than the voltage rating of the second, third, and fourth power supply modules 112, 113, 114 and a current rating (corresponding to a maximum current output) greater than the current rating of the second, third, and fourth power supply modules. In the illustrated embodiment, the LVHC power supply has a voltage rating of 30V and a current rating of 200 A, and each HVLC power supply has a voltage rating of 120V and a current rating of 50 A. When run on a maximum voltage and current setting, the LVHC power supply module has an internal resistance of 0.15Ω and each HVLC power supply has an internal resistance of 2.4Ω. Other modular power supplies can use power supply modules having different voltage and/or current ratings. Equipping the modular power supply system 110 with both HVLC and LVHC power supplies enables substantial flexibility for performing a wide range of different welds. That is, depending on the configuration of the first, second, third, or fourth power supply modules 111, 112, 113, 114, the modular power supply system 110 is capable of providing varying power output to accomplish a wide variety of welds varying in resistance, material, length, width, and temperature.

As shown in Table 1, the terminals for any one of the power supply modules 111, 112, 113, 114 can be connected to the heating element 102 individually, any subset of two or more terminals can be connected to the heating element in series, or any subset of two or more terminals can be connected to the heating element in parallel. As a result, the illustrated modular power supply is selectively configurable to adjust the maximum current from 50 A to 350 A, and to adjust the maximum voltage from 30V to 390V. Additionally, the reconfigurable power supply system 110 enables adjustment of the internal resistance to match as closely as possible the resistance of the heating element being used for the weld. As shown below, in the illustrated embodiment, the internal resistance of the modular power supply is adjustable from 0.09Ω to 7.8Ω. Thus, in one aspect, the present resistance welding apparatus 100 provides a power supply system 100 that is adjustable to a wide range of voltages, currents, and internal resistances (e.g., in one or more embodiments, the voltage range is from 0V to at least 200V, such as from 0V to at least 300V; the current range is from OA to at least 200 A, such as from OA to at least 300 A; and the internal resistance range is from at a minimum of less than or equal to 1Ω to a maximum of greater than or equal to 2Ω, such as a minimum of less than or equal to 0.5Ω to a maximum of greater than or equal to 4Ω, or a minimum of less than or equal to 0.25Ω to a maximum of greater than or equal to 6Ω).

TABLE 1

| | | | | | | | Internal |
|---|---|---|---|---|---|---|---|
| | | | | | | | Resistance |
| | | | | | | | (Ω) at |
| | | | | | Max. | Max. | max, |
| Module | First | Second | Third | Fourth | Voltage | Current | voltage/ |
| Type | LVHC | HVLC | HVLC | HVLC | (V) | (A) | current |
| Connection | Individual | Disconnected | Disconnected | Disconnected | 30 | 200 | 0.15 |
| | Disconnected | Individual | Disconnected | Disconnected | 120 | 50 | 2.4 |

| | | | | | |
|---|---|---|---|---|---|
| Disconnected | Series | Disconnected | 240 | 50 | 4.8 |
| Disconnected | Parallel | Disconnected | 120 | 100 | 1.2 |

| | | | | |
|---|---|---|---|---|
| Disconnected | Series | 360 | 50 | 7.2 |
| Disconnected | Parallel | 120 | 150 | 0.8 |

| | | | | | |
|---|---|---|---|---|---|
| Series | Disconnected | Disconnected | 150 | 50 | 3 |
| Parallel | Disconnected | Disconnected | 30 | 250 | 0.12 |

| | | | | |
|---|---|---|---|---|
| Series | Disconnected | 270 | 50 | 5.4 |
| Parallel | Disconnected | 30 | 300 | 0.1 |

| | | | |
|---|---|---|---|
| Series | 390 | 50 | 7.8 |
| Parallel | 30 | 350 | 0.09 |

Referring to FIG. 4, the resistance welding apparatus 100 further includes a human machine interface (HMI) 126 and a PLC 140 (i.e., a weld controller) supported on the apparatus enclosure 116. In the illustrated embodiment, the HMI 126 is a touchscreen display that allows a user to select a weld control routine. For example, the user can select a weld control routine based on one or more predefined set point temperatures over a predefined weld duration or select a weld control routine based one or more predefined current set points over a predefined duration of the weld, and the weld controller 140 will automatically conduct a welding operation in accordance with the selection.

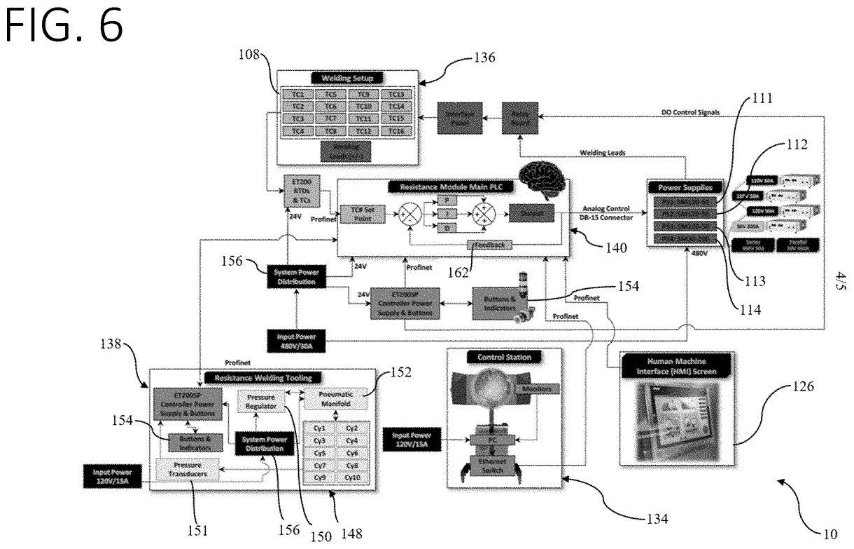

In the illustrated embodiment, the weld controller 140 comprises a closed loop (e.g., PID) controller that controls the weld routine based on feedback from the welding process. That is, the weld controller 140 is configured to output a control signal to the power supply system 110 that varies the output of the power supply system based on feedback from the process as it is being conducted. For example, as explained more fully below, in certain implementations, the weld controller 140 can control the weld routine based on temperature feedback. In addition, the illustrated resistance welding apparatus 100 includes an integrated feedback circuit 162 (FIG. 6) that detects the output signal from the controller to the power supply system 110 and inputs this information to the weld controller 140. In certain implementations, the weld controller 140 uses this power output feedback signal to adjust its control signal output to the power supply system 110 to accord with the predefined current set points of a weld routine.

The resistance welding apparatus 100 further includes a plurality of temperature sensor connectors 108 configured to connect to sacrificial temperature sensors (not shown, e.g., sacrificial RTDs). Each of the sacrificial temperature sensors can be disposed at the interface of the thermoplastic parts 104, 106 to be welded. During a weld, the sacrificial temperature sensors output a temperature signal representative of the temperature of the weld interface. The temperature sensor connectors 108 pass temperature signals from the sacrificial temperature sensors to the controller 140. In certain implementations, the weld controller 140 controls the modular power supply system 110 to execute weld control routines based on one or more temperature signals from one or more sacrificial temperature sensors. For example, in one or more embodiments, a weld control routine includes one or more temperature set points, and the weld controller 140 executes the weld by using PID control logic based on feedback from the temperature sensors to adjust the control signal output to the modular power supply 110 to achieve the set point temperature at the weld joint.

Referring to FIG. 2, the apparatus enclosure 110 also includes a pair of data ports 132 (e.g., Ethernet ports). The data ports 132 are configured to connect the resistance welding apparatus 100 to the remote control station 134 and the resistance welding tooling 138, thereby integrating the system 10 so that the resistance welding apparatus, the control station, and the resistance welding tooling are coordinated. In the illustrated embodiment, the apparatus 100, the remote control station 134, and the welding tooling 138 communicate via Profinet communications, though other control protocols may also be used without departing from the scope of the disclosure. As shown in FIG. 4, the apparatus 100 can comprise one or more I/O device 143 to facilitate communication with one or both of the remote control station 134, 138.

Referring to FIG. 1, the resistance welding tooling 138 is generally configured to press the work pieces 104, 106 together during a welding operation. That is, in one or more embodiments, the resistance welding tooling 138 comprises a press 130. For example, the resistance welding tooling 138 may comprise a pneumatic manifold 152 and a pressure regulator 150 that control the press 130. The resistance welding apparatus 110 can integrate with various different resistant welding tooling 138 depending on how the resistance welding system 100 is being used. For example, when the system 100 is used in a process development mode, the tooling 138 can comprise a fairly small press to provide a small-scale simulation of a much larger production weld. Whereas when the system 100 is used in a production mode, the tooling 138 can include a much larger press.

As shown in FIG. 6, the illustrated resistance welding tooling 138 operates with a loop incorporating a power input of 120V/15 A into a power distribution unit 156. The tooling 138 further comprises pressure transducers 151 configured to detect the pressure being applied by the press during a welding operation. Suitably, the pressure transducers 151 output one or more pressure signals representative of the detected pressure to the weld controller 140. This data can be used by the weld controller 140 to adjust the pressure being exerted by the press 130 in accordance with the parameters of the selected weld routine. In certain embodiments, a user can interact with the resistance welding tooling 138 system through buttons and indicators 154 that are connected to the weld controller 140. For example, the resistance welding apparatus 100 may include an E-stop button connected to the weld controller 140 to stop the weld. If the user presses the E-stop, a weld control routine could be halted in the event of emergency.

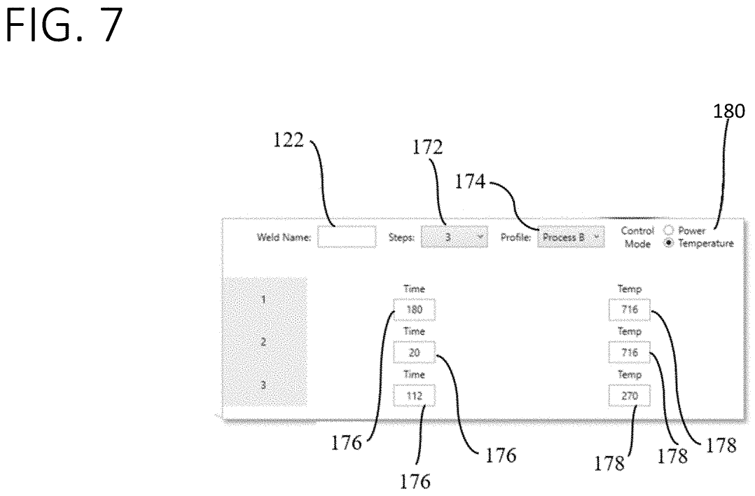

In the illustrated resistance welding system 10, the control station 134 connects to the controller 140 via one of the Ethernet ports 132. The control station 134 includes a computer (e.g., a processor and memory storing processor-executable instructions that are executed) for running weld control software. In certain embodiments, the weld control software enables a user to program a weld control routine. Referring to FIG. 6, in one embodiment, the weld control software enables the user to define a weld routine that can be executed by the weld controller 140. In the illustrated embodiment, the weld control software is configured to define the weld routine in terms of either temperature-versus-time or power-versus-time and store the newly defined weld routine in memory accessible to the controller 140. FIG. 7 shows a user interface for defining the weld routine in terms of temperature-versus-time. As can be seen, the user can name the weld routine at field 170, select the number of time interval steps at field 172, select a profile type at field 174, and then select the time and set point temperature for the weld routine at fields 176, 178. FIG. 7 further depicts a toggle 180 for switching to a programming interface for defining a weld routine in terms of power-versus-time.

During a resistance welding operation, the controller 140 is configured to reference a stored weld routine defined by the weld control software and execute the predefined weld. In one or more embodiments, weld routines programmed by the control station 134 using the weld control software are stored in memory 141 (FIG. 4) that can be accessed by the HMI device on the resistance welding apparatus 100. Thus, after defining a weld routine using the control station 134, the user can then select that weld routine from the HMI 126. To enable the controller 140 to execute a weld based on a weld routine definition created in the weld control software, the weld control software may utilize a standard communication protocol such as Siemens Open Platform Communication (OPC). Those skilled in the art will appreciate that OPC can allow the weld control software to read and write communication “tags” to the memory 141 of the weld controller 140. The tags are data types stored in memory of the weld controller 140 that control data manipulation and hardware processors. A tag is created as a placeholder in memory inside the weld control software, which is then pointed to the static IP address of the tag located in the weld controller memory 141. The tag name and data type, such as float, integer, or Boolean, must be known to read and write data from the tag.

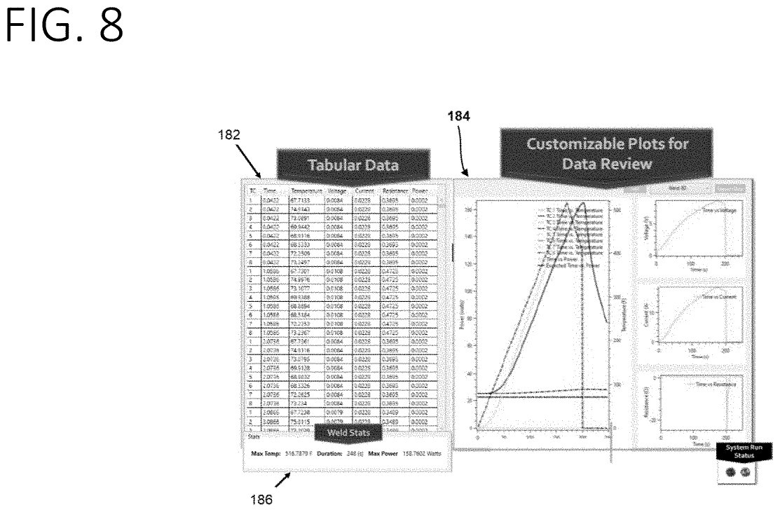

In certain embodiments, the weld controller 140 is configured to store real time data from a welding operation into memory 141 that can be accessed by the weld control software for later visualization, verification, and/or analysis. Thus, the controller memory 141 may be used to store feedback from the resistance welding tooling 138, the temperature sensors, the power feedback circuit 162, etc. More specifically, once a weld control routine is initiated by the HMI 126, pressure and temperature information corresponding to the weld routine may be sent and stored on the memory 141. Additionally, voltage and current information corresponding to the weld control routine may also be sent and stored on the memory 141. The weld control software is configured to access the data obtained by the controller 140 and store it in an external database (not shown). In one or more embodiments, the database is accessed through an SQLite database management system. As shown in FIG. 8, the weld control software is configured to display the process data in a table 182, as well as user selected charts 184. The illustrated weld control software also automatically generates key performance metrics and displays them in the field 186.

A method of using the resistance welding system 10 will now be briefly described. In general, the resistance welding system 10 enables two modes of operation: a process development mode and a production process mode. The process development mode broadly enables the user to determine the power characteristics needed to produce a desired weld. In the production process mode, the welding system 10 is used to perform welds for production purposes (e.g., repeated processes for joining composite parts to be used in an aircraft or other goods).

In the process development mode, the weld control software is used to program a desired weld in terms of temperature-versus-time. Subsequently, the user positions the desired sample work pieces 104, 106 and heating element 102 in the weld tooling 138 so that they are ready to weld. Furthermore, the user connects the desired number of sacrificial temperature sensors to the connectors 108 and positions them at the weld joint. In certain embodiments, the user also configures the modular power supply 110 in a configuration expected to be suitable for the weld. For example, the user may select a power supply configuration with an internal resistance closely matched to the resistance of the heating element 102 placed between the work pieces 104, 106. After the work pieces 104, 106 are in position, the user may select the weld control routine of interest from the HMI 126. Upon instructions from the HMI 126, the weld controller 140 automatically executes a welding operation based on the temperature-versus-time parameters defined in the weld control routine. The controller 140 receives feedback from the sacrificial temperature sensors and uses PID control to continuously adjust the current at the weld interface to achieve a predefined set point temperature. Throughout the weld operation, information from the process is being stored to local controller memory 141. For example, the controller 140 stores information about the current output to the heating element 102 over time, information about the temperatures detected by the sacrificial temperature sensors over time, and information about the amount of pressure being applied by the press 130 over time. This information is non-limiting examples of “weld process data”.

The weld control software reads the weld process data from the local weld controller memory 141 and writes it into an external database. After the weld is complete, the user can physically inspect the weld (e.g., by hand or using any suitable destructive or non-destructive testing procedures) to determine if the weld meets expectations. Additionally, the user can use the weld control software to assess whether the weld process data indicates that the weld was acceptable. For example, the user can assess whether the welding system 10 was able to consistently achieve the desired welding temperatures throughout the weld process. If the weld is unacceptable in any respect, the user can define a new weld control routine using the weld control software and repeat the above process development steps. If the weld is acceptable, the user can evaluate the weld process data and define a new weld control routine based on the weld process data in terms of power-versus-time. For example, the user defines a set of power-versus-time parameters that substantially correspond with the weld process data for the successfully executed weld conducted in the process development mode. Because the weld process data for a weld conducted in a process development mode includes temperature data, the user can have confidence that a new weld control routine programmed so that the defined power-versus-time matches the power-versus-time in the weld process data will yield a weld that substantially conforms to the temperature characteristics achieved when the weld was conducted during the process development mode. Thus, the process development mode can yield weld control routines programmed in terms of power-versus-time that are validated to achieve certain temperature specifications.

In the production process mode, the user can subsequently use the validated weld control routine to repeatably conduct welding operations that conform to the desired temperature specifications. For each weld, the user positions the desired sample work pieces 104, 106 and heating element 102 in the weld tooling 138 so that they are ready to weld. Sacrificial temperature sensors are not required in the production process mode because the production welds are conducted based on routines defined in terms of power-versus-time. The user suitably configures the modular power supply 110 as required by the weld specification, and selects the desired weld control routine using the HMI 126. Upon instructions from the HMI 126, the weld controller 140 automatically executes a welding operation based on the power-versus-time parameters defined in the weld control routine. The controller 140 receives feedback from the feedback circuit 162 and uses closed loop control to continuously adjust the current at the weld interface to achieve the power characteristics defined in the weld control routine. Throughout the weld operation, information from the process is stored to local controller memory 141. For example, the controller 140 stores information about the current output to the heating element over time and information about the amount of pressure being applied by the press 130. The weld control software reads the weld process data from the local weld controller memory 141 and writes it into an external database. After the weld is complete, the weld process data stored in the database serves as a record to validate that the weld was performed according to specification.

Embodiments of the present disclosure may comprise a special purpose computer including a variety of computer hardware, as described in greater detail herein.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein.

Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A resistance welding apparatus for welding thermoplastic parts together at a weld interface in which a resistor is disposed between the thermoplastic parts, the resistance welding apparatus comprising:
a modular power supply system comprising a first power supply module and a second power supply module; and
leads for electrically connecting the modular power supply system to the resistor to output current from the modular power supply system to the resistor;
wherein the resistance welding apparatus is selectively configurable in at least three of (i) a first configuration in which the leads connect the first power supply module to the resistor and the second power supply module is disconnected from the resistor; (ii) a second configuration in which the leads connect the second power supply module to the resistor and the first power supply module is disconnected from the resistor; (iii) a third configuration in which the leads connect the first and second power supply modules to the resistor in series; and (iv) a fourth configuration in which the leads connect the first and second power supply modules to the resistor in parallel.

2. The resistance welding apparatus as set forth in claim 1, wherein the resistance welding apparatus selectively configurable in any of the first configuration, the second configuration, the third configuration, and the fourth configuration.

3. The resistance welding apparatus as set forth in claim 1, wherein the modular power supply system further comprises a third power supply module and the resistance welding apparatus is selectively configurable to connect the first, second, and third power supply modules to the resistor in at least one of parallel and series.

4. The resistance welding apparatus as set forth in claim 3, wherein the modular power supply system further comprises a fourth power supply module and the resistance welding apparatus is selectively configurable to connect the first, second, third, and fourth power supply modules to the resistor in at least one parallel and series.

5. The resistance welding apparatus as set forth in claim 4, wherein the second, third, and fourth power supply modules have the same voltage and current ratings and the first power supply module has different voltage and current ratings.

6. The resistance welding apparatus as set forth in claim 5, wherein voltage rating of the first power supply module is less than the voltage rating of the second, third, and fourth power supply modules and the current rating of the first power supply module is greater than the current rating of the second, third, and fourth power supply modules.

7. The resistance welding apparatus as set forth in claim 1, further comprising an apparatus enclosure, the modular power supply system being received in the apparatus enclosure.

8. The resistance welding apparatus as set forth in claim 7, wherein the apparatus enclosure has a side wall and each power supply module has a positive terminal connector and a negative terminal connector supported on the side wall.

9. The resistance welding apparatus as set forth in claim 7, wherein the apparatus enclosure has a side wall and the resistance welding apparatus further comprises a power connector input on the side wall configured to connect the modular power supply system to a main power source.

10. The resistance welding apparatus as set forth in claim 7, further comprising an HMI device supported on the enclosure.

11. The resistance welding apparatus as set forth in claim 10, wherein the HMI device is configured to receive user input selecting a weld control routine.

12. The resistance welding apparatus as set forth in claim 11, further comprising a weld controller configured to control the modular power supply system to execute a weld control routine selected by user input to the HMI device.

13. The resistance welding apparatus as set forth in claim 12, further comprising a connector for connecting the weld controller to resistance welding tooling including a press, the weld controller configured to at least one of control the press and receive feedback from the press.

14. The resistance welding apparatus as set forth in claim 13, further comprising a memory configured to store feedback from the press during each weld control routine executed by the HMI.

15. The resistance welding apparatus as set forth in claim 14, wherein the memory is configured to store information about at least one of voltage and current outputted by the resistance welding apparatus during each weld control routine executed by the HMI.

16-18. (canceled)

19. A resistance welding apparatus for welding thermoplastic parts together at a weld interface in which a resistor is disposed between the thermoplastic parts, the resistance welding apparatus comprising:
a resistance welding power supply system configured to selectively output current to the resistor;
a weld controller configured to control the power supply system to selectively output current to the resistor to repeatably execute weld routines, wherein the weld controller is configured to connect to one or more sacrificial temperature sensors that may be disposed at the interface of the thermoplastic parts while they are being welded together to output a temperature signal representative of temperature of the weld interface during welding; and
a feedback circuit providing information about the current output from the resistance welding power supply during execution of weld routine;
wherein the weld controller is configured to selectively control weld routines based on feedback from either of (1) one or more sacrificial temperature sensors and (2) the feedback circuit.

20. The resistance welding apparatus as set forth in claim 19 further comprising a memory configured to store the feedback during each weld routine.

21. A method of developing a resistance welding process, the method comprising:
using a weld controller to control a resistance welding power supply of a resistance welding apparatus to output current to a resistor at a weld interface between thermoplastic parts to adjust the weld interface to a predefined set point temperature based on feedback from one or more sacrificial temperature sensors connected to one or more temperature sensor connectors integrated into the resistance welding apparatus; and
storing information about the current output to the resistor during the preceding step.

22. The method as set forth in claim 21, further determining a resistance welding power curve for the resistance welding process based on the stored information.

23. A method of performing a repeatable welding process, the method comprising repeatably controlling a resistance welding power supply of a resistance welding apparatus to output current to a resistor at a weld interface corresponding to the power curve determined in the method of claim 22.
